(19) United States
(12) Patent Application Publication
(10) Pub. No.: US 2016/0052115 A1
(43) Pub. Date: Feb. 25, 2016

(54) TOOL FOR HOLDING COMPONENT

(71) Applicant: Caterpillar Inc., Peoria, IL (US)

(72) Inventors: Mark J. Maggi, Granville, IL (US); Connor S. Widder, Austin, TX (US)

(73) Assignee: Caterpillar Inc., Peoria, IL (US)

(21) Appl. No.: 14/930,670

(22) Filed: Nov. 3, 2015

(51) Int. Cl. B25B 27/14; B25B 9/02

(52) U.S. Cl. CPC B25B 27/146; B25B 9/02

(57) ABSTRACT

A tool for holding a component is provided. The tool includes a handle. The tool also includes an elongated body having a first end and a second end opposite to the first end. The tool further includes a holding assembly. The holding assembly is adapted to hold the component. The holding assembly includes a base portion. The base portion is connected to the second end of the elongated body. The base portion includes a first edge and a second edge opposite to the first edge. The holding assembly also includes a first arm. The first arm includes a first inner surface. The holding assembly further includes a second arm. The second arm includes a second inner surface. The first inner surface and the second inner surface face each other with a gap being defined there between.

### TECHNICAL FIELD

The present disclosure relates to a tool, and more particularly to a tool for holding and positioning a component.

### BACKGROUND

Machines employed in industries such as construction, mining, and transportation requires routing and/or securing of wires, cables, and the like to one or more machine surface. Typically, clips, such as butterfly clips, are used to secure the wires and/or cables to the machine. The clips are coupled to the machine surface using a coupling technique, such as welding. During the coupling of the clip, a personnel is required to manually position and hold the clip at a desired location on the machine surface. However, such a holding technique does not allow an accurate positioning and holding of the clip at the desired location. Further, it is troublesome for the personnel to hold the clip during the coupling process as the clips are small in size.

U.S. Pat. No. 8,535,323, hereinafter referred to as '323 patent, discloses a hand held instrument used in positioning of a constraining ring of an acetabular liner system. The hand held instrument includes a shaft, a first coupling member and a plurality of heads. Each of the plurality of the heads includes a base and a pair of resilient gripper arms. The base is configured to couple with the first coupling member. Each of the pair of resilient gripper arms defines a constraining ring reception area having a size different from the constraining ring reception area defined by the pair of gripper arms of each of the other of the plurality of heads. However, the hand held instrument of the '323 patent does not disclose holding of a component during a coupling process of the component to a surface.

### SUMMARY OF THE DISCLOSURE

In one aspect of the present disclosure, a tool for holding a component is provided. The tool includes a handle. The tool also includes an elongated body having a first end and a second end opposite to the first end. The first end of the elongated body is connected to the handle and a distance between the first end and the second end defines a length of the elongated body. The tool further includes a holding assembly. The holding assembly is connected to the second end of the elongated body. The holding assembly is adapted to hold the component. The holding assembly includes a base portion. The base portion is connected to the second end of the elongated body. The base portion includes a first edge and a second edge opposite to the first edge. A distance between the first edge and the second edge defines a length of the base portion. The holding assembly also includes a first arm. The first arm extends from the first edge of the base portion. The first arm includes a first inner surface. The holding assembly further includes a second arm. The second arm extends from the second edge of the base portion. The second arm includes a second inner surface. The first inner surface and the second inner surface face each other with a gap being defined therebetween. The gap is equal to a width of the component.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective view of a portion of an undercarriage system associated with the machine of FIG. 1.

FIG. 3 is an exploded view illustrating a tool and an exemplary component, according to the one embodiment of the present disclosure;

FIG. 4 is a perspective view of the tool holding the component on a surface of the exemplary machine of FIG. 1; and

FIG. 5 is a zoomed view of portion 5-5 in FIG. 3, showing a holding assembly associated with the tool.

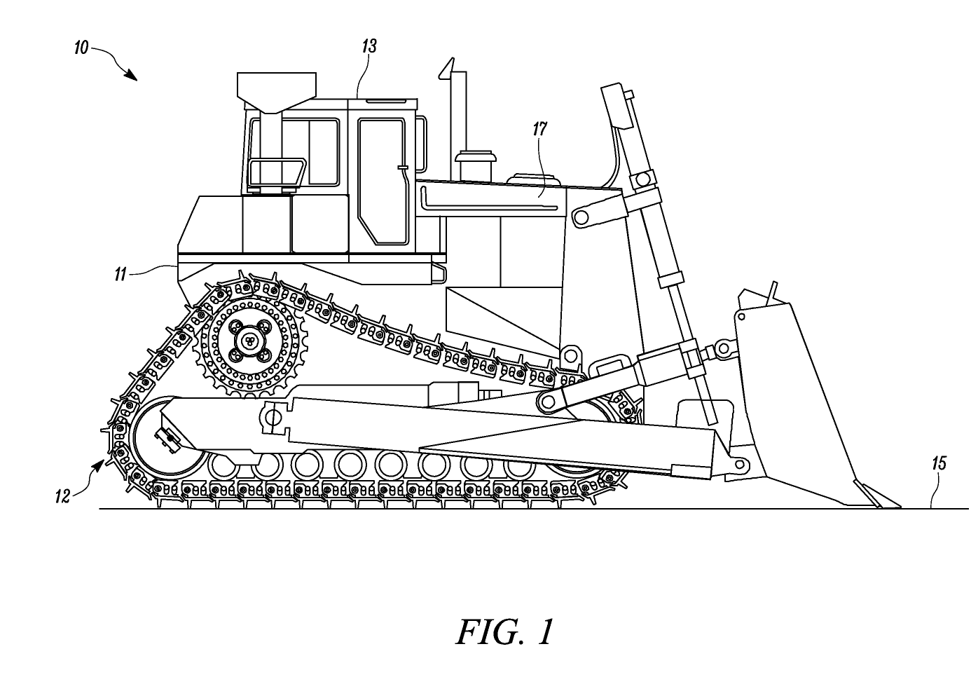

### DETAILED DESCRIPTION

Wherever possible the same reference numbers will be used throughout the drawings to refer to the same or the like parts. FIG. 1 illustrates an exemplary machine 10, according to one aspect of the present disclosure. As illustrated, the machine 10 may embody a track type tractor. Alternatively, the machine 10 may include, but is not limited to, a backhoe loader, a skid steer loader, a wheel loader, a motor grader, an excavator, a scraper, an agricultural tractor, a wheel loader, a haul truck, and the like. It should be understood that the machine 10 may embody any wheeled or tracked machine associated with mining, agriculture, forestry, construction, and other industrial applications.

As illustrated in FIG. 1, the machine 10 is a track type tractor. However, the concepts of the present disclosure may be embodied in a different type of applications such as recreational, appliances, electrical panels and the like. The machine 10 may include a frame 11 supported on an undercarriage system 12. The undercarriage system 12 allows mobility of the machine 10 on a ground surface 15. An operator cabin 13 is supported on the frame 11. Further, a power source (not shown) is provided within an enclosure 17 of the machine 10. The power source provides power to the machine 10. In one embodiment, the power source may include, for example, a diesel engine, a gasoline engine, a gaseous fuel powered engine such as a natural gas engine, a combination of known sources of power or any other type of engine apparent to one of skill in the art. The machine 10 may further include a transmission system (not shown). The transmission system may be communicably coupled to the power source. The transmission system may include a mechanical drive, a hydraulic drive, an electric drive, or a combination thereof.

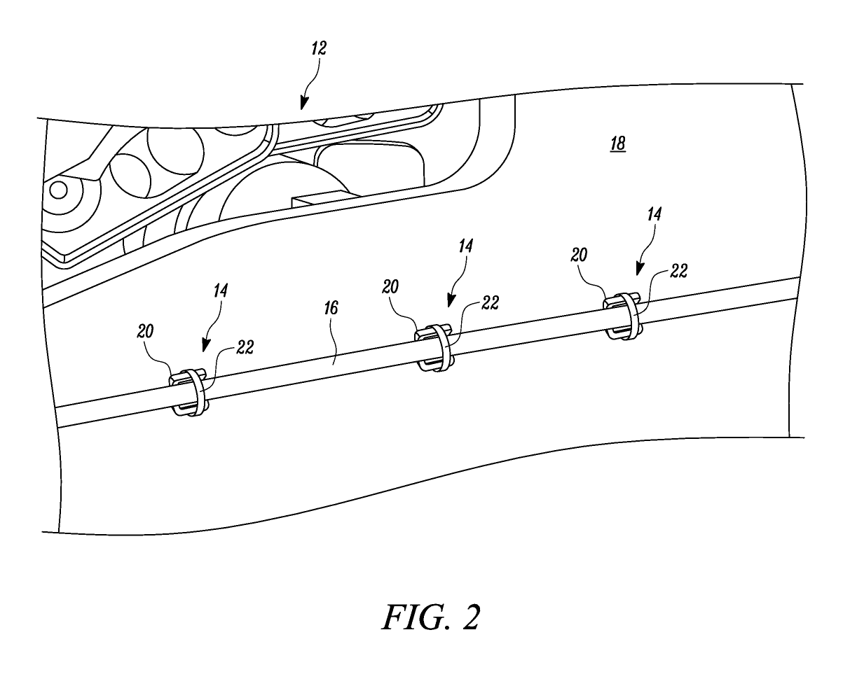

Referring to FIG. 2, a portion of the undercarriage system 12 is shown. Further, a number of clamping arrangements 14 are coupled to a surface 18 of the undercarriage system 12. The clamping arrangements 14 are used for coupling a member 16 to the surface 18. Although the member 16 is shown secured to the surface 18, it is contemplated that the member 16 may be coupled to any component of the machine 10 such as the frame 11, the operator cabin 13, etc. The member 16 may be a flexible member or a rigid member. Further, the member 16 may embody any of a wire/wire harness, a hose, a pipe, a cable, a conduit, and the like. In one example, the member 16 may be a wire harness associated with an electrical system of the machine 10. In another example, the member 16 may embody a hose that allows fluid communication between one or more components of the machine 10. Referring to the accompanying figure, multiple clamping arrangements 14 are shown coupled to the surface 18. The clamping arrangements 14 are aligned and coupled to the surface 18 so that the member 16 may be received by these clamping arrangements 14. Although the figure illustrates three clamping arrangements 14 coupled to the surface 18, the number of clamping arrangements 14 may vary based on system requirements.

The clamping arrangements 14 include a component 20 that is coupled to the surface 18. Further, the component 20 is affixed to the surface 18 using a welding process. Alternatively, a different coupling process, such as soldering or brazing may be used to couple the component 20 with the surface 18. The component 20 may be fastened to the surface 18 using mechanical fasteners such as bolts, pins, rivets, screws, and the like. The component 20 may be made from a variety of materials including, but not limited to, carbon steel, stainless steel, aluminum, plastic, or any other material known in the art. Further, in an exemplary embodiment, the clamping arrangement 14 includes a tie 22. The member 16 is secured to the component 20 using the tie 22. The tie 22 is coupled to the component 20. The tie 22 may be a cable tie, a velcro, a tie-wrap, or any other similar ties known in the art.

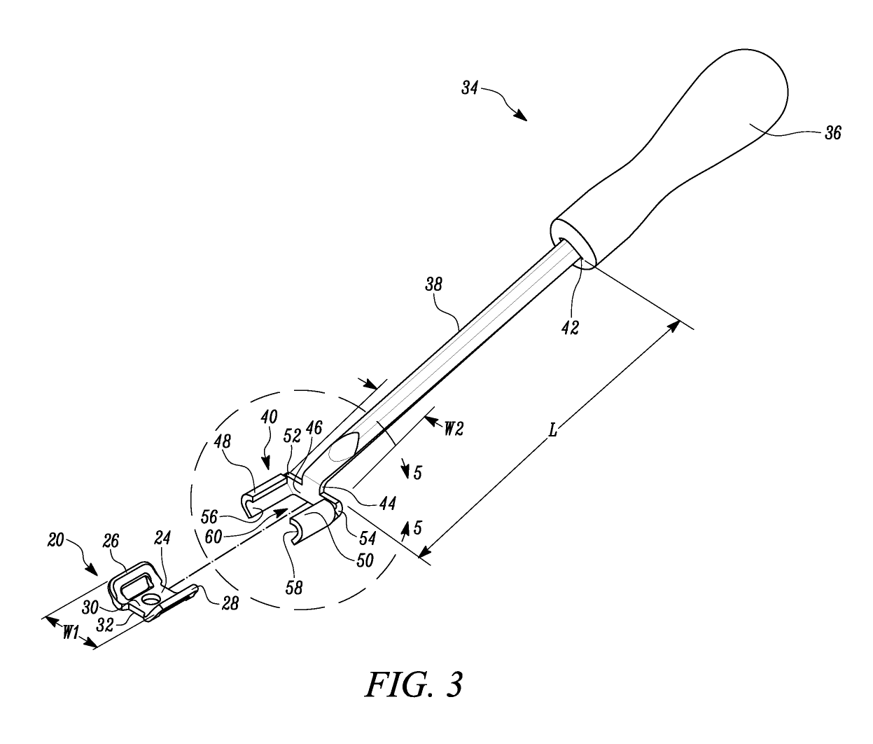

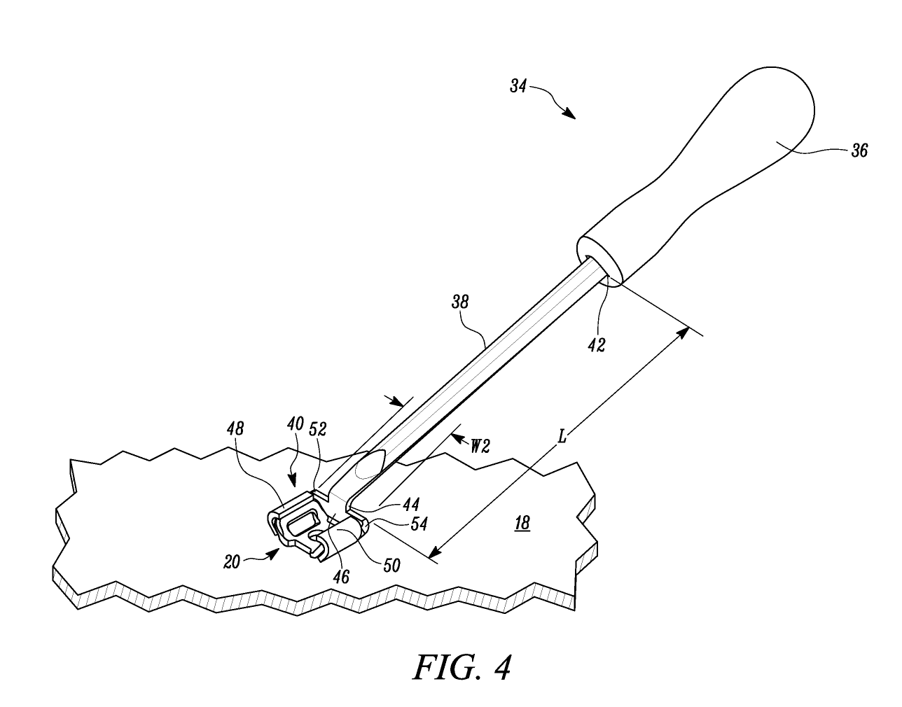

As shown in FIGS. 3 and 4, the component 20 is embodied as a clip, and will be hereinafter interchangeably referred to as the clip 20. The clip 20 is a butterfly clip. In other embodiment, the clip 20 may be a bowtie clip. Alternatively, the clip 20 may embody a different clip or a clamp known in the art that allows securing of the member 16 on the surface 18. The clips may be implemented in any applications that include an electrical routing, a fluid lines routings and the like.

Referring to FIG. 3, the clip 20 includes a body 24. Further, the clip 20 includes a first wing section 26 and a second wing section 28. The first and second wing sections 26, 28 extend from the body 24 of the clip 20. The body 24 has an upper face 30 and a lower face 32. The lower face 32 of the body 24 contacts the surface 18 when the clip 20 is welded to the surface 18. The clip 20 defines a width “W1”.

The present disclosure relates to a tool 34. As shown in the accompanying figure, the tool 34 includes a handle 36. The handle 36 provides a gripping surface that allows a personnel to hold the tool 34 during the welding process. The handle 36 may include protrusions, striations, or any other pattern known in the art that provides firm gripping of the tool 34 by the personnel. The handle 36 may be made of wood, metal, resin, plastic or the like, and may be covered or coated with a comfort-grip material.

The tool 34 also includes an elongated body 38. The elongated body 38 is embodied a bar of variable thickness. Alternatively, the elongated body 38 may have a zig-zag shape, a rod shape, a curved shape, or any other shape known in the art. It should be noted that the shape and material of the elongated body 38 may vary without any limitations.

The elongated body 38 includes a first end 42 and a second end 44 disposed opposite to the first end 42. The distance between the first end 42 and the second end 44 defines a length “L” of the elongated body 38. The first end 42 of the elongated body 38 is connected to the handle 36. Whereas, the second end 44 of the elongated body 38 is connected to a holding assembly 40. The elongated body 38 is inclined with respect to the holding assembly 40, such that an angle is formed between the elongated body 38 and the holding assembly 40. For an example, the angle may lie between 3° to 15°. In one example, the angle may be approximately equal to 5°. The angle between the holding assembly 40 and the elongated body 38 may vary, without limiting the scope of the present disclosure.

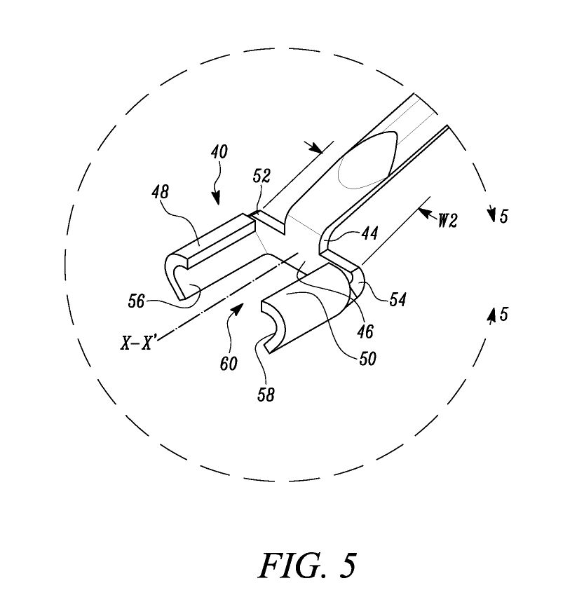

Referring to FIG. 5, the holding assembly 40 includes a base portion 46. The base portion 46 of the holding assembly 40 is connected to the second end 44 of the elongated body 38. The base portion 46 includes a first edge 52 and a second edge 54. The second edge 54 is disposed opposite to the first edge 52. The distance between the first edge 52 and the second edge 54 defines a width “W2” of the base portion 46.

The holding assembly 40 includes a first arm 48 and a second arm 50. The first arm 48 is disposed in parallel to the second arm 50. The first arm 48 and the second arm 50 of the holding assembly 40 are symmetrically placed about an axis X-X′ passing through a center of the base portion 46. During the welding process, the first and second arms 48, 50 are configured to contact the first wing section 26 and the second wing section 28 of the clip 20 respectively.

The first arm 48 and the second arm 50 have an arcuate shape to accommodate the first and second wing section 26, 28 of the clip 20. The shape of the first and second arms 48, 50 may vary to accommodate different configurations of the clip 20. The first arm 48 and the second arm 50 of the holding assembly 40 may have equal lengths or different lengths depending on the design of the clip 20 that is to be held between the first arm 48 and the second arm 50 of the holding assembly 40.

The first arm 48 of the holding assembly 40 extends from the first edge 52 of the base portion 46. The first arm 48 includes a first inner surface 56. Further, the second arm 50 of the holding assembly 40 extends from the second edge 54 of the base portion 46. The second arm 50 includes a second inner surface 58. The first and second inner surfaces 56, 58 define a gap 60 therebetween. The gap 60 is substantially equal to the width “W1” of the clip 20 so that the clip 20 is held in the gap 60 and still easy to engage or disengage with the tool 34.

The tool 34 may be manufactured as a single unitary component. Alternatively, the tool 34 may be manufactured as separate individual units that are later assembled to form the tool 34. In other embodiments, the holding assembly 40 may be in a C-shaped fashion, wherein the elongated body 38 is attached to any one of the first arm 48 or the second arm 50. Such a design may be helpful to hold the clip 20 using the tool 34 with one hand and easy to access a weld gun to weld the clip 20 to the surface 18 with the other hand. Further, any additive or subtractive manufacturing process known in the art may be used to manufacture the tool 34. For example, the tool 34 may be manufactured using casting, forming, molding, or any other manufacturing technique known in the art. In one example, the tool 34 may be formed by a stamping process.

Further, the tool 34 may be made from a variety of different materials, such as, spring steel, stainless steel, aluminum, or any other materials known in the art, without limiting the scope of the present disclosure. The tool 34 may be heat treated before and/or after the fabrication of the tool 34 to obtain optimal properties depending on the choice of material and method of manufacturing.

### INDUSTRIAL APPLICABILITY

Positioning and holding of the clips 20 in places that are difficult to access is troublesome for the personnel who is in charge of the coupling process. The present disclosure may find applicability in reducing/eliminating any risk of injury to the personnel, and to better facilitate the positioning and holding of the clip 20 in an isolated or hard to reach place.

The present disclosure relates to the tool 34 that is used to position and hold the clip 20 on the surface 18 during the welding process of the clip 20 to the surface 18. More particularly, the personnel in charge of the welding process may position and hold the clip 20 using the tool 34 during the welding process. The tool 34 disclosed herein provides an easy to use, handheld self-biasing holding tool that facilitates accurate positioning and holding of the clip 20 during the coupling process. Further, the tool 34 provides a cost effective solution for the positioning and holding of the clip 20.

The holding assembly 40 of the tool 34 is designed to allow secure holding of the clip 20 therein, thus any possibility of clip movement during the coupling process is reduced. The tool 34 also includes the elongated body 38 and the handle 36 that allows simplified positioning and holding of the clip 20 during the coupling process. Further, the tool 34 allows the personnel to orient the clip 20 easily during the coupling process of the clip 20 to different surfaces.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A tool for holding a component, the tool comprising:
a handle;
an elongated body having a first end and a second end opposite to the first end, the first end connected to the handle, and a distance between the first end and the second end defining a length of the elongated body; and
a holding assembly connected to the second end of the elongated body, the holding assembly adapted to hold the component, the holding assembly including:
a base portion connected to the second end of the elongated body, the base portion having a first edge and a second edge opposite to the first edge, a distance between the first edge and the second edge defining a length of the base portion;
a first arm extending from the first edge of the base portion, the first arm having a first inner surface; and
a second arm extending from the second edge of the base portion, the second arm including a second inner surface, the first inner surface and the second inner surface face each other with a gap being defined therebetween,
wherein the gap is equal to a width of the component.
